(19) United States
(12) Patent Application Publication
(10) Pub. No.: US 2025/0247017 A1
(43) Pub. Date: Jul. 31, 2025

(54) VOLTAGE SOURCE MULTI-LEVEL CONVERTER TOPOLOGY AND CONTROL METHOD THEREOF

(71) Applicant: SHANDONG UNIVERSITY, Jinan, Shandong (CN)

(72) Inventors: Hao TIAN, Jinan (CN); Feng GAO, Jinan (CN)

(73) Assignee: SHANDONG UNIVERSITY, Jinan, Shandong (CN)

(21) Appl. No.: 18/688,973

(22) PCT Filed: Jul. 17, 2023
(86) PCT No.: PCT/CN2023/107741

§ 371 Date: Mar. 4, 2024

(30) Foreign Application Priority Data
Jun. 20, 2023 (CN) 202310736660.5

(51) Int. Cl. H02M 7/483; H02J 1/10; H02M 1/00; H02M 7/5387

(52) U.S. Cl. CPC H02M 7/4837; H02J 1/10; H02M 1/0095; H02M 7/53871

(57) ABSTRACT

A voltage source multi-level converter topology and a control method thereof. The voltage source multi-level converter topology includes two groups of half-bridge circuits, two groups of flying capacitors and a plurality of switches. Each group of half-bridge circuits include two direct-current connection ends, and outputs of the two groups of half-bridge circuits are both connected, through a switch, to the two groups of flying capacitors that are in series. A neutral point of a connection between the two groups of flying capacitors is connected to an alternating-current end through two switches that are in reverse series, and an overall positive electrode and an overall negative electrode of the two groups of flying capacitors that are in series are respectively connected to the alternating-current end through switches.

The present invention claims priority to Chinese Patent Application No. 202310736660.5, entitled “VOLTAGE SOURCE MULTI-LEVEL CONVERTER TOPOLOGY AND CONTROL METHOD THEREOF”, and filed with the China National Intellectual Property Administration on Jun. 20, 2023, which is incorporated herein by reference in its entirety.

### TECHNICAL FIELD

The present invention relates to the field of power electronics conversion technologies, and in particular, to a voltage source multi-level converter topology and a control method thereof.

### BACKGROUND

Descriptions of this part mainly provide a background technology related to the present invention, but do not necessarily constitute a conventional technology.

A power electronics converter can implement flexible power conversion, and actively control a voltage, a current, and a power. Therefore, the power electronics converter is widely used. Because a voltage endurance requirement of an internal power semiconductor component can be reduced by using multi-level topology based on a design of a topological structure, and the multi-level topology has advantages such as few output harmonics, a low voltage change rate, and a low common mode voltage, the multi-level topology is widely used in a medium-high voltage high power converter.

However, a topological structure of a multi-level converter with a large quantity of output levels is usually a complex structure. A topological structure with a modular characteristic, such as cascaded multi-level topology or modular multi-level topology, usually has high costs and a large size because the topological structure depends on a passive component such as a transformer or a capacitor. Alternatively, a non-modular topological structure is also common and practical. However, simple topology generally can only produce a small quantity of output levels, which are mainly three or five levels, such as three-level neutral point clamped topology or five-level active neutral point clamped topology. On the other hand, topology that has a simple structure and produces a large quantity of output levels usually has a limited operating range and is difficult to operate with a wide range of power factor and modulation index, such as hybrid seven-level topology.

Therefore, it is usually difficult for current topology to take account of a quantity of output levels, structure simplicity, and an operating range. A topological structure with more than five levels, a simple structure, and a wide operating range urgently needs to be proposed.

### SUMMARY

To solve a defect of an existing technology, the present invention provides a voltage source multi-level converter topology and a control method thereof. The structure is simple and easily controlled, and can be widely used in an application scenario of medium/low voltage alternating current-direct current conversion.

To achieve the foregoing object, the following technical solutions are used in the present invention.

A first aspect of the present invention provides a voltage source multi-level converter topology.

A voltage source multi-level converter topology is provided, including two groups of half-bridge circuits, two groups of flying capacitors and a plurality of switches.

Each group of half-bridge circuits comprise two direct-current connection ends, and outputs of the two groups of half-bridge circuits are both connected, through a switch, to the two groups of flying capacitors that are in series.

A neutral point of a connection between the two groups of flying capacitors is connected to an alternating-current end through two switches that are in reverse series, and an overall positive electrode and an overall negative electrode of the two groups of flying capacitors that are in series are respectively connected to the alternating-current end through switches.

Further, the alternating-current end does not cascade a full-bridge inversion unit.

Further, the alternating-current end cascades one or more full-bridge inversion units.

Further, if the alternating-current end cascades n full-bridge inversion units, 6*2ⁿ+1 levels are generated.

Further, the direct-current connection end is connected to a single direct-current power supply and three split direct-current capacitors.

Further, four direct-current connection ends are connected to three direct-current link capacitors, and the capacitors are connected in series and then connected to the direct-current power supply.

Further, the direct-current connection end is connected to a plurality of direct-current power supplies.

A second aspect of the present invention provides a voltage source multi-level converter, where the voltage source multi-level converter topology described in the first aspect is used as a phase bridge arm.

Further, different bridge arms share a direct-current side.

A third aspect of the present invention provides a control method of the voltage source multi-level converter topology described in the first aspect, and the method includes the following step:
driving each switch to execute a respective switching state, and generating different current paths from a direct-current end to the alternating-current end, to enable a voltage at the alternating-current end to present different levels.

In comparison with an existing technology, a beneficial effect of the present invention is as follows.
1. In the voltage source multi-level converter topology described in the present invention, each phase bridge arm includes a switch pipe and a flying capacitor. A direct-current side of the phase bridge arm includes four connection ends, which can be connected to three direct-current link capacitors. The capacitors are connected in series and then connected to a direct-current power supply, or may be connected to three independent direct-current power supplies. Based on an application requirement, a single-phase, three-phase, or multi-phase alternating current-direct converter can be formed by using half a bridge, a full bridge, a three-phase bridge, or even more bridge arms, so that the structure of the converter is simple and easily controlled, and has advantages such as an inherent low switching voltage stress of the multi-level converter and a small output harmonic.
2. The voltage source multi-level converter topology described in the present invention can be widely used in an application scenario of medium/low voltage alternating current-direct current conversion.

### BRIEF DESCRIPTION OF DRAWINGS

The accompanying drawings constituting a part of the present invention are used for providing further understanding for the present invention. Example embodiments of the present invention and descriptions thereof are used for explaining the present invention and do not constitute an improper limitation to the present invention.

FIG. 1 is a schematic diagram of a voltage source multi-level converter topology according to Embodiment 1 of the present invention;

FIG. 2 is a schematic diagram of a multi-level topology in which a single direct-current power supply and three split direct-current capacitors are used according to Embodiment 1 of the present invention;

FIG. 3 is a schematic diagram of a multi-level topology in which three direct-current power supplies are used according to Embodiment 1 of the present invention;

FIG. 4(a) is a schematic diagram of a structure in which more levels are expanded in the multi-level topology according to Embodiment 1 of the present invention;

FIG. 4(b) is a diagram of a structure of an expansion module of the multi-level topology according to Embodiment 1 of the present invention;

FIG. 5(a) is a schematic diagram of a structure of a single-phase H bridge constructed by using multi-level topology according to Embodiment 1 of the present invention;

FIG. 5(b) is a schematic diagram of a structure of a three-phase converter constructed by using multi-level topology according to Embodiment 1 of the present invention;

FIG. 5(c) is a schematic diagram of a structure of an n-phase converter constructed by using multi-level topology according to Embodiment 1 of the present invention; and

FIG. 6 is a schematic diagram of a typical output waveform and an expected output according to Embodiment 3 of the present invention.

### DESCRIPTION OF EMBODIMENTS

The following further describes the present invention with reference to the accompanying drawings and embodiments.

It should be noted that the following detailed descriptions are an example, and are intended to provide further descriptions of the present invention. Unless otherwise specified, all technical and scientific terms used in this specification have the same meaning as commonly understood by a person of ordinary skill in the art to which this application belongs.

It should be noted that terms used herein are only for describing specific implementations and are not intended to limit example implementations according to the present invention. As used herein, the singular form is intended to include the plural form, unless the context clearly indicates otherwise. In addition, it should further be understood that terms “comprise” and/or “include” used in this specification indicate that there are features, steps, operations, devices, components, and/or combinations thereof.

For convenience of description, the words “upper”, “lower”, “left” and “right”, if exist in the present invention, only indicate upper, lower, left and right directions consistent with those of the accompanying drawings, are not intended to limit the structure, and are used only for ease of description of the present invention and brevity of description, rather than indicating or implying that the mentioned device or element needs to have a particular orientation or needs to be constructed and operated in a particular orientation. Therefore, such terms should not be construed as a limitation on the present invention.

In the present invention, terms such as “fixedly connected”, “connected”, or “connection” should be understood in a broad sense, indicating being fixedly connected, being in an integral connection or a detachable connection, being directly connected, or being indirectly connected by using an intermediate medium. For a related scientific researcher or technician in the field, a specific meanings of the foregoing terms in the present invention can be determined based on a specific condition, and should not be understood as a limitation to the present invention.

Embodiments and features of embodiments of the present invention may be combined with each other without conflict.

### Embodiment 1

Embodiment 1 of the present invention provides a voltage source multi-level converter topology.

The voltage source multi-level converter topology provided in this embodiment can be widely used in an application scenario of medium/low voltage alternating current-direct current conversion.

In the voltage source multi-level converter topology provided in this embodiment, each phase bridge arm includes a switch pipe and a flying capacitor. A direct-current side of the phase bridge arm includes four connection ends, which can be connected to three direct-current link capacitors. The capacitors are connected in series and then connected to a direct-current power supply, or may be connected to three independent direct-current power supplies. Based on an application requirement, a single-phase, three-phase, or multi-phase alternating current-direct converter can be formed by using half a bridge, a full bridge, a three-phase bridge, or even more bridge arms. The structure of the converter is simple and easily controlled, and has advantages such as a low switching voltage stress and a small output harmonic. The present invention can be widely used in an application scenario of medium/low voltage alternating current-direct current conversion.

The voltage source multi-level converter topology provided in this embodiment includes a multi-level circuit with a T-shaped structure and three split direct currents and an optional cascaded full-bridge inversion unit. A direct-current side connection circuit includes three split direct-current sides and four direct-current connection ends in total. The four ends are divided into two groups to connect to half-bridge circuits. Outputs of the two half-bridge circuits are each connected to a series switch, and then connected to the T-shaped structure. The T-shaped structure includes two groups of flying capacitors that are in series. A neutral point of a connection between the capacitors is connected to an alternating-current end through two switches that are in reverse series. An overall positive electrode and an overall negative electrode of the capacitors that are in series are also connected to the alternating-current end through switches respectively. The alternating-current end can produce a multi-level output by using a direct-current side voltage and a voltage on the flying capacitor of the T-shaped structure, and a current can flow in both directions.

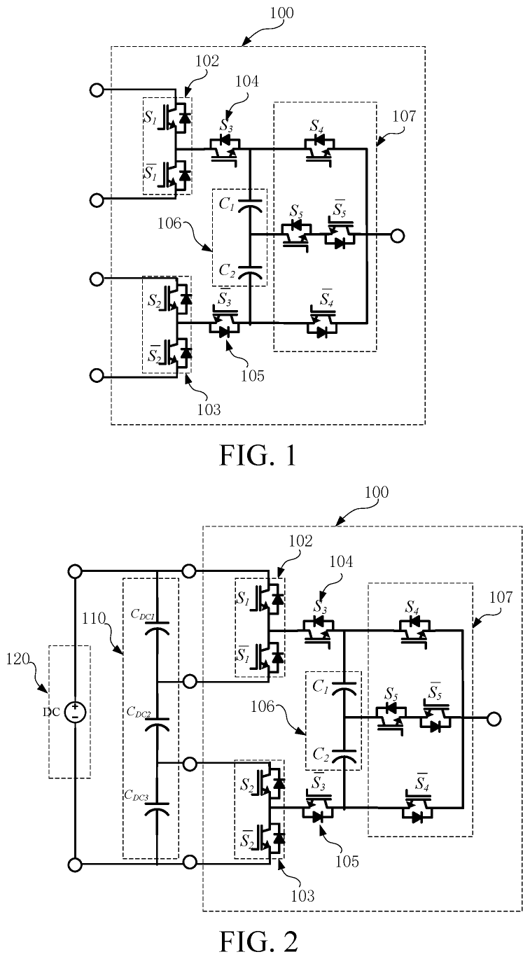

Specifically, as shown in FIG. 1, a topology 100 of a voltage source multi-level converter provided in this embodiment includes two groups of connected half-bridge circuits, namely, a first connected half-bridge circuit 102 and a second connected half-bridge circuit 103. The first connected half-bridge circuit 102 includes two switches S₁ and S̅₁̅ that are in series. The two switches S₁ and S̅₁̅ that are in series each include a direct-current connection end. A neutral point of a connection between the two switches S₁ and S̅₁̅ that are in series is connected to a series switch (S₃) 104. The second connected half-bridge circuit 103 includes two switches S₂ and S̅₂̅ that are in series. The two switches S₂ and S̅₂̅ that are in series each include a direct-current connection end. A neutral point of a connection between the two switches S₂ and S̅₂̅ that are in series is connected to a series switch (S̅₃̅) 105. The two series switches S₃ and S̅₃̅ are connected to a T-shaped switch circuit 107 through two groups of flying capacitors 106 (including a flying capacitor C₁ and a flying capacitor C₂) that are in series. A neutral point of a connection between the two groups of flying capacitors is connected to an alternating-current end through two switches (S₅ and S̅₅̅) that are in reverse series. The switch S₃ is also connected to the alternating-current end through the switch S₄. The switch S̅₃̅ is also connected to the alternating-current end through the switch S̅₄̅.

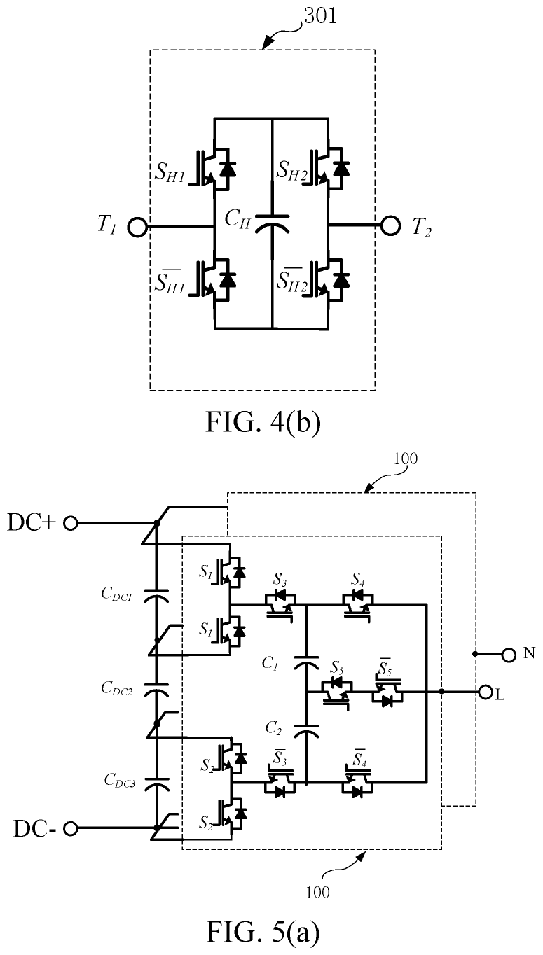

As shown in FIG. 4(a) and FIG. 4(b), the voltage source multi-level converter topology provided in this embodiment may cascade or not cascade one or more full-bridge inversion units 301. The multi-level circuit with the T-shaped structure may generate seven levels. When cascading a full-bridge conversion structure, each time a full-bridge inversion unit is added, the entire structure can generate additional six levels in combination with the multi-level circuit with the T-shaped structure and the three split direct currents. A structure including n full-bridge inversion units can generate 6*2ⁿ+1 levels.

As shown in FIG. 4(a) and FIG. 4(b), each full-bridge inversion unit 301 includes switches S_{H1}, S̅_̅{̅H̅1̅}̅, S_{H2}, and S̅_̅{̅H̅2̅}̅. S_{H1} and S̅_̅{̅H̅1̅}̅ are connected in series to form a half-bridge structure. A center of the half-bridge structure is a connection end T₁, configured to connect S̅₅̅ or a connection end T₂ of a previous full-bridge inversion unit 301. S_{H2} and S̅_̅{̅H̅2̅}̅ are also connected to form a half-bridge structure. A center of the half-bridge structure is the connection end T₂, configured to connect the connection end T₁ of the next full-bridge inversion unit 301. A floating capacitor C_{H} is connected to the two half bridges in parallel.

The voltage source multi-level converter topology provided in this embodiment can be used as a phase bridge arm of a converter, to form a single-phase full-bridge, three-phase bridge, or multi-phase bridge system. Different quantities of bridge arms may share a direct-current side. The direct-current side can be a power supply, a capacitor, or a load. The power supply and the load may be connected to the entire direct-current side, or may be divided into three groups and connected to four direct-current ends respectively.

FIG. 2 shows a multi-level topology in which a single direct-current power supply 120 and three split direct-current capacitors 110 are used, that is, a capacitor is connected between every two adjacent direct-current connection ends in four direct-current connection ends. Specifically, a capacitor C_{DC1} is connected between the direct-current connection ends connected to the switches S₁ and S̅₁̅, a capacitor C_{DC2} is connected between the direct-current connection ends connected to the switches S̅₁̅ and S₂, a capacitor C_{DC3} is connected between the direct-current connection ends connected to the switches S₂ and S̅₂̅, and the capacitor C_{DC1} and the capacitor C_{DC3} are respectively connected to positive and negative electrodes of the direct-current power supply 120.

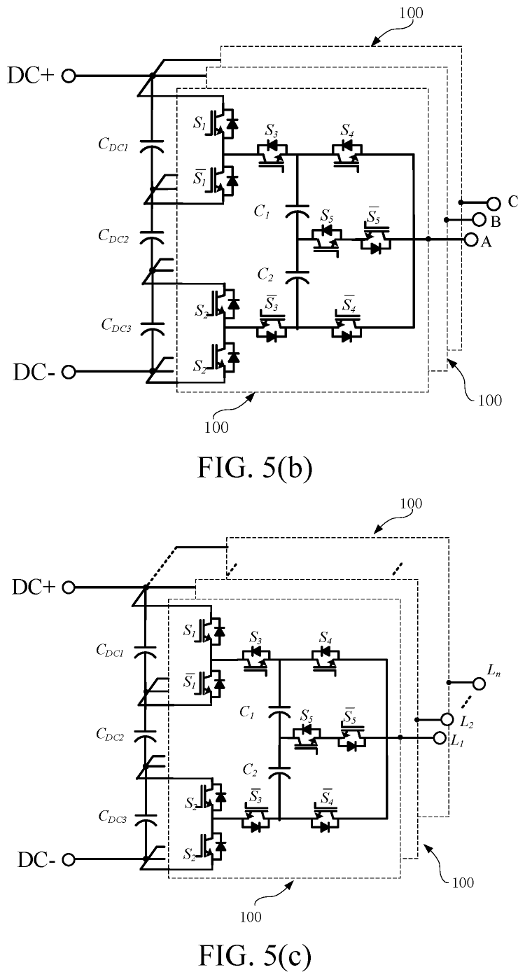

FIG. 5(a), FIG. 5(b), and FIG. 5(c) are respectively schematic diagrams of structures of a single-phase H bridge, a three-phase converter, and an n-phase converter constructed by using multi-level topology of the present invention.

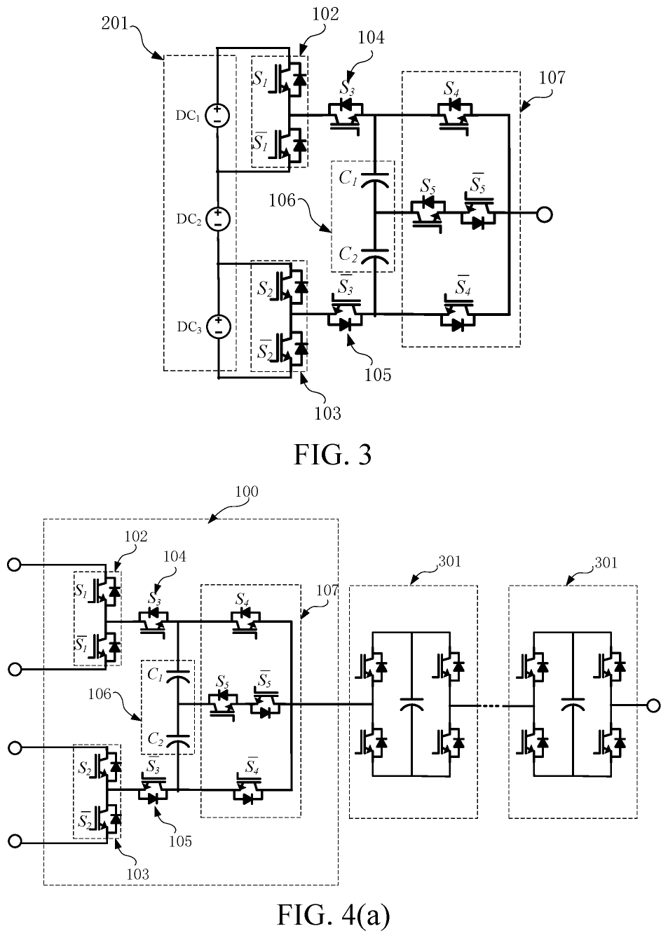

FIG. 3 shows a multi-level topology in which three direct-current power supplies 201 are used, that is, a direct-current power supply is connected between every two adjacent direct-current connection ends in four direct-current connection ends. Specifically, a direct-current power supply DC₁ is connected between the direct-current connection ends connected to the switches S₁ and S̅₁̅, a direct-current power supply DC₂ is connected between the direct-current connection ends connected to the switches S̅₁̅ and S₂, and a direct-current power supply DC₃ is connected between the direct-current connection ends connected to the switches S₂ and S̅₂̅.

The voltage source multi-level converter topology provided in this embodiment can output a plurality of levels by using a simple structure and has a plurality of types of direct-current link construction manners, and can be applied to single-phase, three-phase, and multi-phase systems.

### Embodiment 2

Embodiment 2 of the present invention provides a voltage source multi-level converter, where the voltage source multi-level converter topology in Embodiment 1 is used as a phase bridge arm.

Different bridge arms share a direct-current side.

### Embodiment 3

Embodiment 3 of the present invention provides a control method of the voltage source multi-level converter topology in Embodiment 1. Each switch is driven to execute a respective switching state, and different current paths from a direct-current end to the alternating-current end are generated, to enable a voltage at the alternating-current end to present different levels. Specifically, the following steps are included.
(1) A control system generates a sinusoidal modulation reference signal through closed-loop control or open-loop modulation.
(2) An expected output voltage is generated or a switch state of each switch is directly generated by using the modulation reference signal based on a multi-level modulation policy, such as carrier stack modulation or carrier phase shift modulation.
(3) A switch in topology is driven to generate a switch status, where different current paths from a direct-current end to an alternating-current end are generated based on different switch states. Because voltages at direct-current ends are different, different quantities of flying capacitors are flowed through, and a voltage at the alternating-current end show different levels.

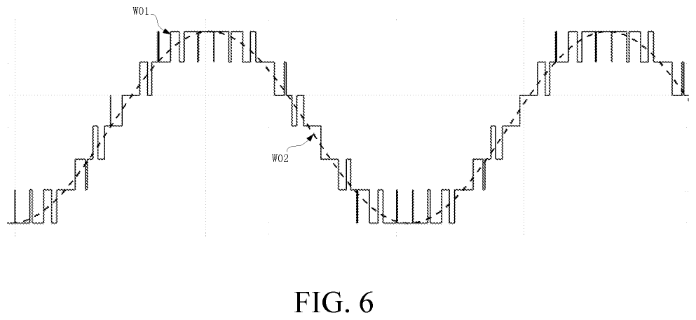

The different levels are output based on a reasonable sequence, so that fundamental components of the different levels are equivalent to an expected sinusoidal modulation reference. FIG. 6 shows a typical output of the different levels. W01 is a multi-level alternating-current voltage output generated by the topology, and W02 is an expected voltage fundamental component, namely, a modulation reference waveform. Based on different quantities of configured expansion modules, a generated multi-level voltage waveform has different quantities of levels, but the fundamental component needs to always be equivalent to the modulation reference.

The foregoing descriptions are only preferred embodiments of the present invention and are not intended to limit the present invention. For a person skilled in the art, the present invention may have various modifications and changes. Any modifications, equivalent substitutions, improvements, and the like made within the spirit and principle of the present invention shall be included in the protection scope of the present invention.

What is claimed is:

1. A voltage source multi-level converter topology, wherein the voltage source multi-level converter topology comprises two groups of half-bridge circuits, two groups of flying capacitors and a plurality of switches, wherein
each group of half-bridge circuits comprise two direct-current connection ends, and outputs of the two groups of half-bridge circuits are both connected, through a switch, to the two groups of flying capacitors that are in series; and
a neutral point of a connection between the two groups of flying capacitors is connected to an alternating-current end through two switches that are in reverse series, and an overall positive electrode and an overall negative electrode of the two groups of flying capacitors that are in series are respectively connected to the alternating-current end through switches.

2. The voltage source multi-level converter topology according to claim 1, wherein the alternating-current end does not cascade a full-bridge inversion unit.

3. The voltage source multi-level converter topology according to claim 1, wherein the alternating-current end cascades one or more full-bridge inversion units.

4. The voltage source multi-level converter topology according to claim 3, wherein if the alternating-current end cascades n full-bridge inversion units, 6*2n+1 levels are generated.

5. The voltage source multi-level converter topology according to claim 1, wherein the direct-current connection end is connected to a single direct-current power supply and three split direct-current capacitors.

6. The voltage source multi-level converter topology according to claim 5, wherein four direct-current connection ends are connected to three direct-current link capacitors, and the capacitors are connected in series and then connected to the direct-current power supply.

7. The voltage source multi-level converter topology according to claim 1, wherein the direct-current connection end is connected to a plurality of direct-current power supplies.

8. A voltage source multi-level converter, wherein the voltage source multi-level converter topology according to claim 1 is used as a phase bridge arm.

9. The voltage source multi-level converter according to claim 8, wherein different bridge arms share a direct-current side.

10. A control method of the voltage source multi-level converter topology according to claim 1, wherein the method comprises the following steps:
driving each switch to execute a respective switching state, and generating different current paths from a direct-current end to the alternating-current end, to enable a voltage at the alternating-current end to present different levels.
